(19) United States
(12) Patent Application Publication
(10) Pub. No.: US 2008/0054004 A1
(43) Pub. Date: Mar. 6, 2008

(54) Adjustable drip pan for drive chain maintenance

(76) Inventor: Paul Andrew Dudzinski, East Berlin, CT (US)

Correspondence Address: Paul Dudzinski, 49 Stony Mill Lane, East Berlin, CT, 06023, US

(21) Appl. No.: 11/899,042

(22) Filed: Sep. 4, 2007

Related U.S. Application Data
(60) Provisional application No. 60/841,941, filed on Sep. 2, 2006.

(51) Int. Cl. F16N 31/02; B65D 25/00; F16N 33/00; F01M 11/04

(52) U.S. Cl. 220/573; 141/98; 184/1.5

(57) ABSTRACT

A fluid capturing device designed to sanitize the chore of motorcycle chain maintainance. The three major components of this device are a drain channel 14, a flexible tube 12, and a container 10. The drain channel is long and slender and designed to fit under a chain to capture the fluid the drips off the chain. The channel has vertical walls around its perimeter and a floor with a slope. The Far wall 16 is tall enough to guard the tire and chassis components from getting splashed. The near wall 18 is substantially shorter to allow unfettered access to the lower portion of the chain, which is the portion that gets serviced. The flexible tube 12 supports the drain channel in an elevated position and allows adjustment in elevation and orientation. This tube also conveys the captured fluids away from the drain channel and into the container. The container 10 is designed to temporarily hold the fluids captured during service and to serve as a stable base. A drain cap 11 on the container allows the fluids to be drained off into a permanent storage container. A handle 13 lends convenience to carrying and positioning of the device.

### FEDERALLY SPONSORED RESEARCH

Not Applicable

### SEQUENCE LIST OR PROGRAM

Not Applicable

### BACKGROUND

### 1. Field of Invention

This invention relates to fluid capturing devices, specifically for the purpose of motorcycle drive chain maintenance.

2. Description of Prior Art

The design and use of fluid capturing and fluid diverting devices is known in prior art from general use pans and containers to those which incorporate additional features for specialized applications. Many commercially available variants of these devices have been created to ease their use in specific applications such as capturing fluid being drained from an engine, or hydraulic system on a car, truck, airplane or stationary machinery. These types of applications require the capture of fluid from a point source i.e. a drain hole. Devices made for such applications are designed to have a broad target surface to guarantee that the draining fluid is captured as its flow varies from a full stream to the last final drops. None of the currently available fluid collecting devices is really suitable for this task.

Chains are maintenance intensive drive components. Most manufacturers of chains typically recommend that chains be cleaned and oiled in intervals of 500-1000 miles in order for the chain to meet its expected usage life. The use of a general purpose pan to capture the effluence created during chain cleaning results in a large amount of fluid finding its way onto the vehicle's tire, other components, and the floor. Drive chains are long, slender, and closely situated to parts of the vehicle's chassis. The specific position of the chain varies based on the vehicle model, but, in all cases, is in a confined space that appears to defy any favorable placement of a general use type drain pan. Special stands are commonly used to elevate the chassis and hold it upright during service. These stands typically support the vehicle chassis in the vicinity of the drive chain and therefore serve to further encumber the placement of a drain pan.

3. Objects and Advantages

The present invention serves to overcome the limitations described above in the prior art. Several of the objects and advantages of the present invention are:

(a) to provide a device with the physical size and form to allow it to fit within the confines of the chassis of the vehicle that is being serviced.

(b) to provide a device which is universal in nature so that it can be used with a broad spectrum of vehicle makes and models.

(c) to provide a device which can be conveniently adjusted to optimum position during usage

(d) to provide a device with the ability to simultaneously capture fluid dripping from many points along the span of the drive chain.

(e) to provide a device with the ability to minimize the splashing of cleaning fluid, or oil, on the various parts and components of the chassis that are in the vicinity of the drive chain.

(f) to provide a device which can be produced economically from plastic materials.

Further objects and advantages are to provide an apparatus that can that offers a high level of convenience to discourage the owner from procrastinating in performing a messy and un-appealing chore. Still further objects and advantages will be apparent while reading the specification and studying the drawings.

### SUMMARY

The present invention is a fluid-capturing device designed to assist with the task of chain cleaning and oiling on, motorcycles. It is designed to be adjustable so that it may be correctly positioned under the chain of a motorcycle, or bicycle, that is being serviced. The degree of adjustability afforded by the present invention allows it to work with a broad spectrum of vehicle makes and models.

### DRAWINGS

Drawing Figures

FIG. 1 is an assembly drawing of the preferred embodiment

FIG. 1a is a sectional view of an articulated tube

FIG. 2 is a frontal view of the preferred embodiment showing pitch adjustment of the drain channel

FIG. 3 is a plan-form view of the drip channel showing angular adjustment in horizontal plane

FIG. 4 is an axisymmetric view of drip channel showing height adjustability

FIG. 5 is an axisymmetric view of drip channel showing angular adjustability along the drain channel axis

FIG. 6 is a sectional view of an additional embodiment showing an alternate type of flexible tube

FIG. 7 is an assembly drawing of an additional embodiment

FIG. 8 is an assembly drawing of an alternate embodiment

FIG. 9 is a drawing of another alternate embodiment

### REFERENCE NUMERALS IN DRAWINGS

10 drain pan base and container

11 drain cap

12 flexible tube

13 base handle

14 drain channel

16 far wall (splashguard)

18 near wall

20 drain channel rear lip

22 drain channel floor

24 drain channel near wall (sprocket end)

26 strip formed flex shaft

27 mechanical joint of tube to channel

28 chassis clamp

30 ball and socket joint

32 articulated support arm

34 friction adjustment screw

36 swing arm

38 drain tube

40 ball end, tube segment

42 socket end, tube segment

### DETAILED DESCRIPTION

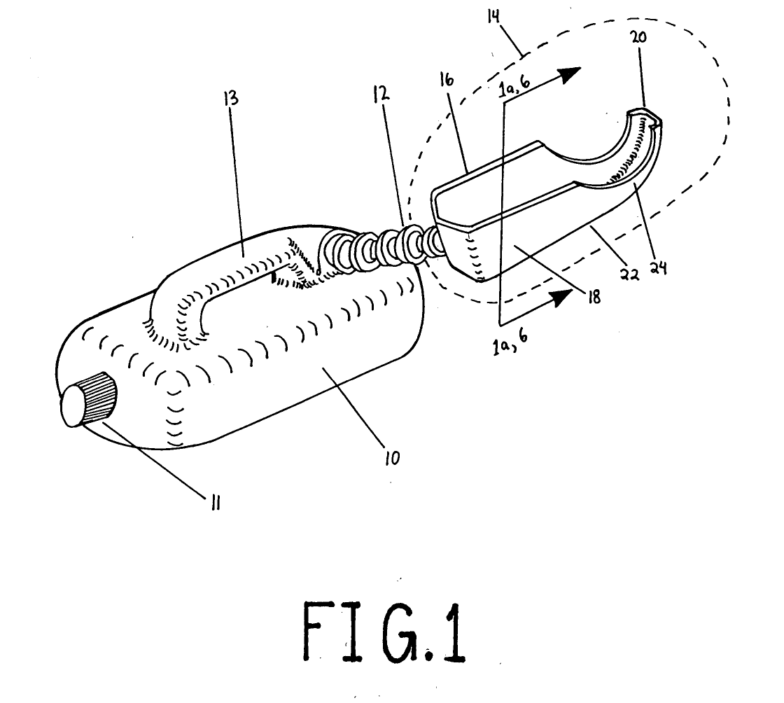

### Description—FIGS. 1 Through 5—Preferred Embodiment

A preferred embodiment of the invention is shown in FIG. 1. The adjustable drip pan is an assembly comprised of three major elements—a base 10, a flexible tube 12 that is anchored to the base, and a slender drain channel 14 that is attached to the far end of the flexible tube, or shaft. The tube is flexible and can be manipulated during positioning of the drain pan and yet will hold a specific position after the preferred position has been achieved.

Base 10 of the preferred embodiment serves two functions. The first function is that of a stable platform to maintain the assembly in a specific position during usage. The second function is that of a container to store all the fluid being captured. The base has a low profile shape that allows it to fit universally under most motorcycle models and yet remain stable. A base handle 13 helps with transporting and positioning of the adjustable drip pan. A cap 11 is incorporated to allow the collected fluids to be drained off. The base is to be made of a thermoplastic material. Two suitable plastics are polypropylene and polyethylene. They are resistant to solvents, tough, and inexpensive. The base can be made by thermoforming, rotational molding, or blow molding.

Flexible tube 12 is a lightweight articulated assembly made of ball and socket segments. A ball end 40 of each segment couples with A socket end 42 of the next segment. This type of articulated assembly allows adjustment in rotation, translation, and angulation. These types of tubes are made of plastic and common in industrial applications. These tubes are ready made and can be purchased from various manufacturers with threaded ends for joining with other components. An alternative method of joining the flex tube to the base and drain channel would be to thermally weld the end elements, of the tube, to the base and drain channel components.

Drain channel 14 is long and slender to fit within the confines of a vehicle chassis and possesses a shape that has been optimized to envelop the lower portion of the chain being serviced. It has a raised far wall 16 to prevent fluids from splashing onto the tire and chassis of the vehicle. A near wall 24, at the sprocket end of the channel, is shaped such that its upper edge approximates the curve of the lower portion of the drive chain as it wraps around the rear sprocket. The forward portion of the drain channel has a low wall that is attached to near wall 18, far wall 16, and floor 22. This wall prevents captured fluids from spilling out of the channel. The channel also has a raised and curved rear lip 20 to allow it catch any drips that would fall from the chain as it curls upward from the rear sprocket A channel floor 22 is designed to have a slope when the channel is positioned correctly under the vehicle being serviced. The slope of the drain channel floor forces captured fluids to flow toward the attachment point of flexible tube 12. The flexible tube is attached to the drain channel at the lowest point of the channel floor to allow the captured fluids to drain away through the tube to the container base. The material and manufacturing method to produce the drain channel would be similar to those described for base 10.

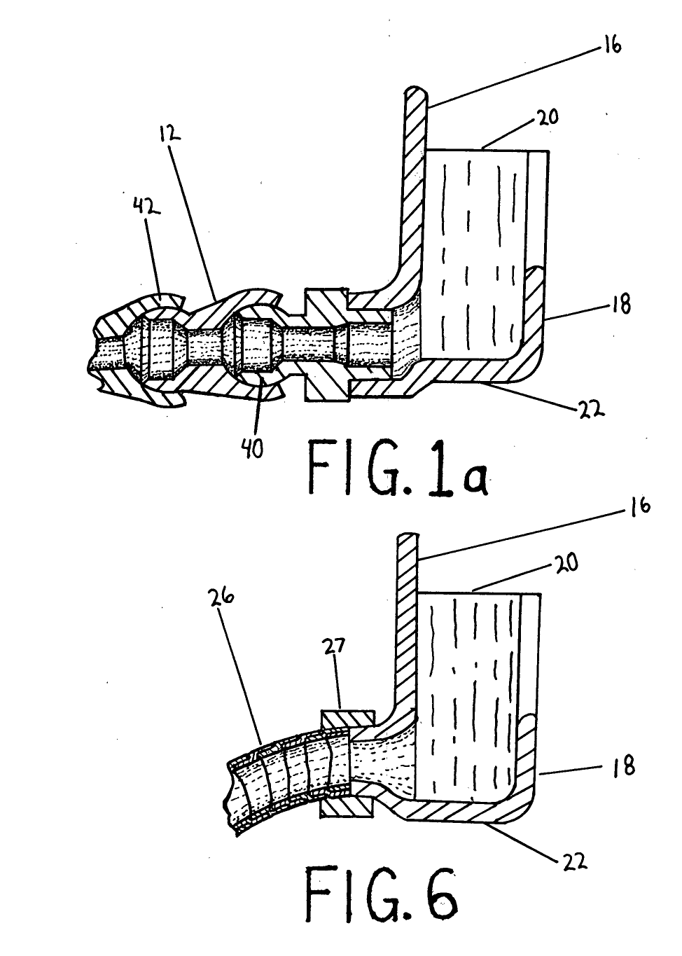

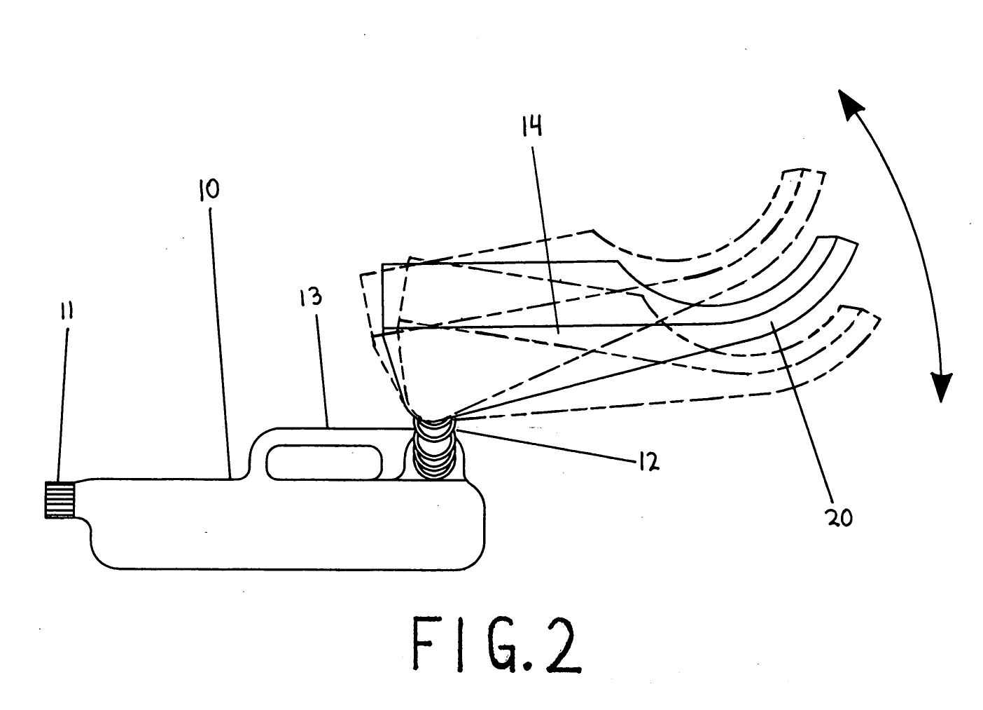

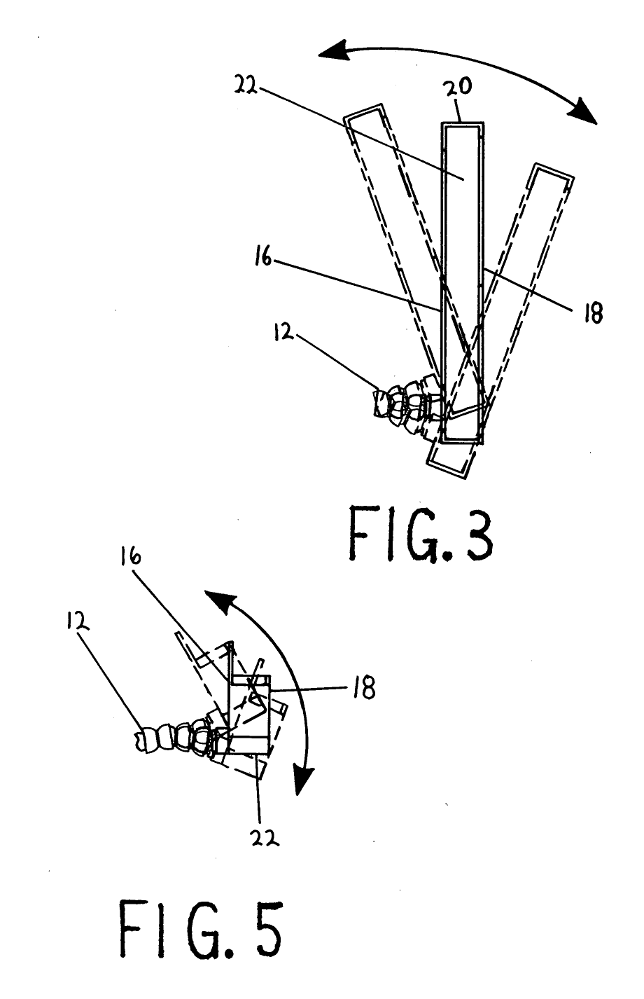

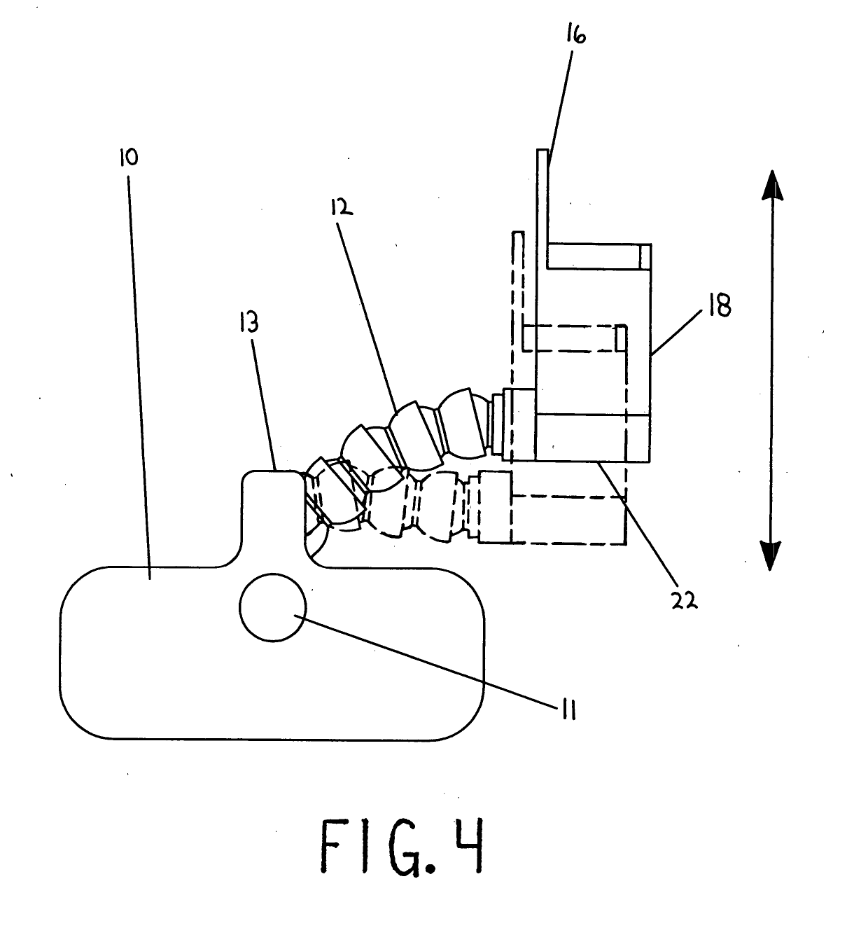

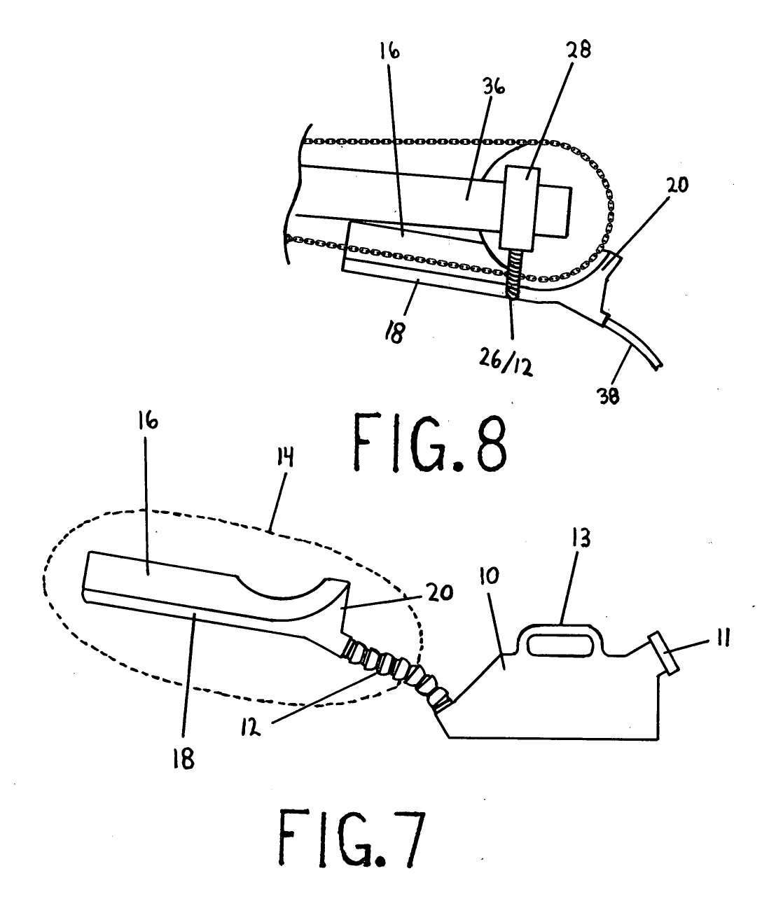

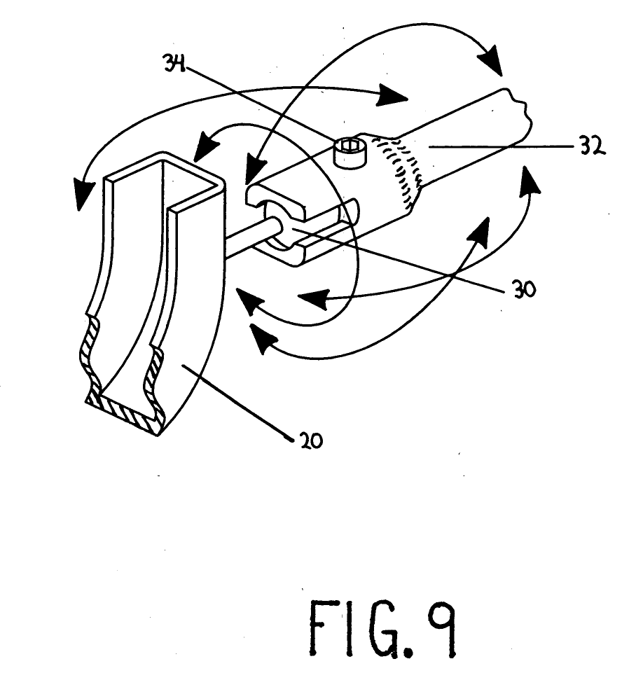

Examples of the drip pan's adjustability are depicted in FIGS. 2 through 5. FIG. 2 is a side view of the assembly and demonstrates the how the channel can be adjusted in pitch. The ball and socket joints of the flexible tube rotate with respect to each other during pitch adjustment. FIG. 3 is a plan form view of the drain channel and demonstrates how the channel can be adjusted in rotation. The ball and socket elements of each segment in the flexible tube change in angle with respect to each other to allow rotation of the drain channel. FIG. 4 is an axisymmetric view of the drain pan assembly and demonstrates adjustability of the drain channel height while keeping its relative orientation the same. It can be seen that drain channel floor 22 has changed height by comparing the solid and phantom lines. Also, near wall 18 and far wall 16 are shown to be oriented vertically for both height positions of the drain channel. FIG. 5 is an axisymmetric view of the drain channel and demonstrates how the drain channel orientation can be changed while keeping the same relative height. Near wall 18 and far wall 16 of the drain channel are shown oriented in a few of the possible angles.

The many degrees of freedom shown in the examples above allow the device to have the adjustability to cover various vehicle models and situations encountered. This device can adjust to a motorcycle that is leaning on it's side stand, or propped upright on either a center stand, or an aftermarket swing arm stand.

### FIG. 6—Additional Embodiment

An additional embodiment is shown in FIG. 6 and is similar to the preferred embodiment as depicted in FIG. 1a, with the exception of an alternate type of flex tube 26. This type of tube is constructed of wound interlocking metal strip and provides the drain channel with adjustability equivalent to that of the articulated ball and socket tube discussed in the preferred embodiment. In addition, this alternate tube can convey the captured fluids from the drain channel to the base as discussed in the preferred embodiment. This type of tube is a commercial product and can be sourced from a number of manufacturers or distributors. The tube can be coupled to the drain channel and tube by a variety of mechanical means. One such method is to use a crimp sleeve 27 to form a permanent joint.

### FIG. 7—Additional Embodiment

FIG. 7 shows an additional embodiment of the invention. This embodiment is comprised of all the same major components of the preferred embodiment, but the arrangement of the components has been altered to allow base 10 to be position behind the rear tire. Flexible tube 12 has been repositioned to the lower portion of rear lip 20. The floor of drain channel 14 is shaped so that the rear portion of the channel is the lowest point in the channel. This allows the collected drippings to flow toward the flexible tube, so that it may drain away through the tube. The fluid is collected by base 10 that doubles as a container. This embodiment possesses all the advantages described in the preferred embodiment.

### FIG. 8-9—Alternative Embodiments

These embodiments have a clamp 28 that is designed as an alternative base. The clamp can be used to affix the drip channel to the chassis of the vehicle being serviced. The preferred place to clamp the apparatus on is the swing arm, on the same side that the drive chain is located. The drain channel in these embodiments is very similar to the previous embodiments and functions in the same way as the preferred embodiment. The main difference between the drain channel in this alternate embodiment is that the channel either has additional depth to hold a greater volume of liquid without the need for draining, or the liquid being drained off is done so through a discrete drain tube 38 into a separate container. The position adjustment of the drain channel, in these alternate embodiments, are done either through an articulated tube 12 or 26, as in FIG. 8, or a jointed support arm as shown in FIG. 9.

The position of articulated tube 12, in FIG. 8, is shown to be located toward the rear of the vehicle, but its actual position is not critical to function. The tube can be located at the opposing end, or at some point along the span of the drain channel, provided that it provides the required support and adjustability. Also, its position should not impede access to the chain in the vicinity of the drain channel during service.

The alternate embodiment, shown in FIG. 9, uses a jointed support arm 32 in place of the articulated tube. This arm is adjustable in movement and in the amount of friction available for holding position. The arm uses a ball and socket joint 30, or multiple joints of this type, to allow rotation, translation, and angulation. The friction available for holding power is adjusted through the use of a clamp screw 34 that adjusts the clamp load on the socket or hinge.

### Operation—FIGS. 1 Through 6—Preferred Embodiment

The motorcycle to be serviced preferably should be placed onto a support stand that will allow it to stay vertical during the service. The drip pan can then be placed adjacent to the motorcycle to allow the rough positioning of the drain channel prior to placement of the drip pan under the motorcycle chassis. Drain channel 14 needs to be adjusted so that the drain channel is low enough to allow far wall 16 to pass under the drive chain and end up positioned between the rear tire and drive chain. At the same time, base 10 is positioned under the motorcycle chassis so that it rests on the floor, just forward of the rear tire. The drain channel should end up positioned so that it is parallel to the drive chain, and under it, when viewed from a perspective directly above the chain, looking down upon it. The drain channel is then ready to be raised vertically so that near wall 18 has approximately ½ to 1 inch gap between the top of the near wall and the chain directly above it when viewed laterally from the side of the motorcycle. The chain should be centered between near 18 and far 16 walls, when viewed from above, to function correctly. The vertical gap between the chain and top of the drain channel's near wall 18 should be approximately equidistant along its full span. Rear lip 20 should wrap around the lower half of the motorcycle's rear sprocket. The chain and sprocket should be centered between the near and far walls of the rear lip when viewed from above.

Cleaning of the drive chain can commence after positioning is done. The drive chain needs to be wetted down with kerosene, aerosol penetrating oils or any solvent that is recommended by the manufacturer. This solvent can be applied by brushing, or spraying, The chain can then be scrubbed down with a stiff, short bristled brush to loosen the caked on dirt. Work should be done only the portion of the chain that is being guarded by the drain channel. Once scrubbing is completed, that portion of the chain is rinse down with additional solvent to drain away the loose crud. Rotating the rear wheel advances the chain links. The chain is advanced until the transition zone between the dirty and clean links, of the chain, is positioned near the forward portion of the drain channel. These steps are repeated until the chain has been completely scrubbed down and cleaned. The drain pan should be kept under the chain, after completing the cleaning, to capture the majority of the drips. Once the solvent has drained off to the point that drips are occasional, the pan can be removed and the chain can be wiped down with a rag. The pan can then be placed back into position as described above to perform the chain lubrication. The chain should be lubed in a manner, and with a lubricant, that is recommended by the manufacturer.

### Operation—FIG. 7—Additional Embodiment

The operation of this embodiment is identical to that of the preferred embodiment described in FIG. 1 through FIG. 6 with the exception of placement of the drip pan base. In this embodiment, base 10 needs to be placed behind the rear wheel and not before it.

### Operation—FIGS. 8 and 9—Alternative Embodiments

The embodiments in these figures require a different method of positioning the drain pan assembly than the preferred embodiment, but the cleaning procedure is the same. The assembly is first adjusted so that the drain channel is clear of all the motorcycle chassis components when clamp 28 is affixed to the swing arm. The drain channel is then positioned so that near wall 18 is below, and parallel to, the lower portion of the drive chain. The chain should be centered between near wall 18 and far wall 16 when viewed from above. There should be a consistent gap of approximately an inch between the chain and the upper edge of near wall 18 when viewed laterally (from the side of the vehicle). Drain tube 38 should be routed into a separate container. The chain can then be cleaned in a manner as described in the operation of the preferred embodiment.

### Conclusion, Ramification, and Scope

The reader can see that this drip pan invention can be produced in a number of configurations and still have the functionality required to work universally on the variety of motorcycle makes and models. This invention can have the means of positional adjustment separate from the means of conveying fluid to the container, or they can be combined together as one component. The base, which offers stability to the drain channel, can be the fluid container, or the base and container can be two discrete components. Although there are many configurations which can offer similar performance, the simplest configurations would be the most economical to manufacture.

This drip pan invention can serve the needs of both road riding enthusiasts and off-road riders, since they both have chain drives and are subject to accumulated grime. The needs of these two groups can be met either by a single model for both, or by separate models for each market segment. Manufacturing separate models for each market segment allows the models to be similar in construction, but have parts that are designed for an optimum fit. Off-road motorcycles tend to have a higher stature, with a longer chain that hangs in a more vertical orientation than that found on a street going motorcycle. The off road specific model can have a longer drain channel to accommodate the longer drive chain. It can have a means of adjustment that is longer, or has a greater amount of angular adjustment to allow the channel to be pitched at the required higher pitch. The base can also be optimized for use on off-road motorcycles. It can be made taller and/or longer to be stable and reach the chain, even when the motorcycle is placed on a relatively tall “works” type support stand.

The description above contains a variety of embodiments that can function with similar effectiveness, but these should not be construed as limiting the scope of this invention, but as examples of some of the preferred embodiments that meet the spirit of this invention. The scope of this invention should be determined by appended claims rather than the examples given.

What is claimed is:

1. An apparatus for capturing and collecting fluids used during drive chain cleaning and lubricating, comprising:
(a) a drain channel constructed from plastic that is long and slender and has a raised and curved rear lip, said channel has a raised wall on the far side of a predetermined height to shield any chassis components from splashing, said channel has a substantially shorter near wall and a short front wall that prevents captured fluid from pouring out, said channel further having a floor with a slope to guide the captured fluid to a drain port
(b) a first means of conveying fluid captured by the drain channel to a container
(c) a second means of support and positional adjustment to hold said drain channel in a range of possible elevated positions and orientations
(d) a container for storing fluids captured by the drain channel.

2. The fluid capturing apparatus of claim 1, wherein said first means of conveying fluid and said second means of support and positional adjustment are provided by an articulated tube composed of ball and socket segments, said tube is attached to said drain channel and said container and relies on said container to supply the apparatus's stability.

3. The fluid capturing apparatus of claim 1, wherein said first means of conveying fluid and second means of support and positional adjustment are provided by a tube made of spiral wound and inter-locked metal strip, said tube is attached to said drain channel and said container and relies on said container to supply the apparatus's stability.

4. The fluid capturing apparatus of claim 1, wherein said second means of support and positional adjustment is provided by an articulated tube composed of ball and socket segments, said tube is attached to said drain channel and said container and relies on said container to supply the apparatus's stability.

5. The fluid capturing apparatus of claim 1, wherein said second means of support and positional adjustment is provided by a tube made of spiral wound and inter-locked metal strip, said tube is attached to said drain channel and said container and relies on said container to supply the apparatus's stability.

6. The fluid capturing apparatus of claim 1, wherein the second means of support and positional adjustment is provided by a jointed support arm with multiple ball and socket joints, said support arm is attached to said drain channel and said container and relies on said container to supply the apparatus's stability.

7. The fluid capturing apparatus of claim 1, wherein said first means of conveying fluid to the container is provided by a plastic tube.

8. The fluid capturing apparatus of claim 1, wherein said first means of conveying fluid to the container is provided by a rubber tube.

9. The fluid capturing apparatus of claim 4, wherein said first means of conveying fluid to the container is provided by a plastic tube.

10. The fluid capturing apparatus of claim 4, wherein said first means of conveying fluid to the container is provided by a rubber tube.

11. The fluid capturing apparatus of claim 5, wherein said first means of conveying fluid to the container is provided by a plastic tube.

12. The fluid capturing apparatus of claim 5, wherein said first means of conveying fluid to the container is provided by a rubber tube.

13. The fluid capturing apparatus of claim 6, wherein said first means of conveying fluid to the container is provided by a plastic tube.

14. The fluid capturing apparatus of claim 6, wherein said first means of conveying fluid to the container is provided by a rubber tube.

15. The fluid capturing apparatus of claim 1, wherein said second means of support and positional adjustment is provided by an articulated tube made of ball and socket segments, said tube is attached to said drain channel and a clamping type base, said base provides the required stability for the apparatus and clamps onto the vehicle's chassis, or the vehicle's support stand.

16. The fluid capturing apparatus of claim 1, wherein said second means of positional adjustment is provided by a tube made of spiral wound and inter-locked metal strip, said tube is attached to a clamping type base, said base provides the required stability for the apparatus and clamps onto the vehicle's chassis, or the vehicle's support stand.

17. The fluid capturing apparatus of claim 1, wherein said second means of support and positional adjustment is provided by jointed support arm with multiple ball and socket joints, said arm is attached to said drain channel and a clamping type base, said base provides the required stability for the apparatus and can clamp onto the vehicle's chassis, or the vehicle's support stand.

18. An apparatus for capturing and collecting fluids used during drive chain cleaning and lubricating, comprising:
(a) a drain channel constructed from plastic that is long and slender and has a raised and curved rear lip, said channel has a raised wall on the far side of a predetermined height to shield any chassis components from splashing, said channel has a substantially shorter near wall and a short front wall that prevents captured fluid from pouring out, said channel further having a floor with a slope to guide the captured fluid to a drain port
(b) a container for storing the fluids that are captured by the drain channel, said container supplies an additional function of providing a stable base for the assembled apparatus.
(c) an articulated tube composed of ball and socket segments, said tube is attached to said drain channel and said container, said tube supplies the required support and positional adjustment for said drain channel to hold it in a range of possible elevated positions and orientations, said tube also conveys any fluids captured by said drain channel to said container.

19. An apparatus for capturing and collecting fluids used during drive chain cleaning and lubricating, comprising:
(a) a drain channel constructed from plastic that is long and slender and has a raised and curved rear lip, said channel has a raised wall on the far side of a predetermined height to shield any chassis components from splashing, said channel has a substantially shorter near wall and a short front wall that prevents captured fluid from pouring out, said channel further having a floor with a slope to guide the captured fluid to a drain port
(b) a container for storing the fluids that are captured by the drain channel, said container supplies an additional function of providing a stable base for the assembled apparatus.
(c) a flexible tube made of spiral wound and inter-locked strip, said tube is attached to said drain channel and said container, said tube supplies the required support and positional adjustment for said drain channel to hold it in a range of possible elevated positions and orientations, said tube also conveys any fluids captured by said drain channel to said container.

20. An apparatus for capturing and collecting fluids used during drive chain cleaning and lubricating, comprising:
(a) a drain channel constructed from plastic that is long and slender and has a raised and curved rear lip, said channel has a raised wall on the far side of a predetermined height to shield any chassis components from splashing, said channel has a substantially shorter near wall and a short front wall that prevents captured fluid from pouring out, said channel further having a floor with a slope to guide the captured fluid to a drain port
(b) a container for temporary storage of fluids that are captured by the drain channel
(c) a clamping type base that provides the required stability for the apparatus and clamps onto the vehicle's chassis, or the vehicle's support stand
(d) an articulated tube composed of ball and socket segments, said tube is attached to said drain channel and said clamping base, said tube supplies the required support and positional adjustment for said drain channel to hold it in a range of possible elevated positions and orientations
(e) a flexible tube to convey the captured fluids from said drain channel to said container
